(19) United States
(12) Patent Application Publication
(10) Pub. No.: US 2006/0268194 A1
(43) Pub. Date: Nov. 30, 2006

(54) Liquid crystal display device

(75) Inventors: Seiji Morimoto, Tottori-shi (JP); Takashi Taniguchi, Tottori-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO EPSON IMAGING DEVICES CORP., Tokyo (JP)

(21) Appl. No.: 11/431,516

(22) Filed: May 11, 2006

(30) Foreign Application Priority Data
May 30, 2005 (JP) 2005-156679

(51) Int. Cl. G02F 1/1335

(52) U.S. Cl. 349/65

(57) ABSTRACT

A liquid crystal display device is provided wherein decline of the driver IC's drive performance due to transmission of heat from the light source is prevented, and which is equipped with a light source of good luminous efficiency that can realize high brightness even when the LEDs are small-sized.

Such a liquid crystal display device 1 comprises: an edge light type backlight device 2 having a light guide plate 21 and a light source 22 that is deployed close to an edge surface of said light guide plate 21; and a liquid crystal display panel 3 wherein a pair of substrates 31, 32 are deployed facing each other, a liquid crystal layer is formed between the two substrates 31, 32, and a driver IC 33 for driving the liquid crystal is mounted on one substrate 31 of said pair of substrates 31, 32. Such liquid crystal display panel 3 is placed over said backlight device 2 to form the liquid crystal display device 1, wherein said driver IC 33 is placed close to an edge other than the edge where the light source 22 of said backlight device 2 is located. Also, the light source 22 is made up of one or more LEDs.

### BACKGROUND OF THE INVENTION

The present invention relates to a liquid crystal display device equipped with a liquid crystal display panel and a backlight device. More particularly it relates to a liquid crystal display device in which it is possible to prevent both decline of the drive performance of the driver IC mounted on a substrate of the liquid crystal display panel, and decline of the luminous efficiency of the light source composed of light-emitting diodes that is used for the backlight device; and furthermore which can be utilized as a high-brightness light source despite being small-sized.

The liquid crystal display devices that have come into widespread use as image display device over recent years generally include a pair of glass substrates, between which a liquid crystal layer is formed to make a liquid crystal display panel, which is then placed over a backlight device composed of a light source, light guide plate and other elements, so as to form the display device.

In some cases a liquid crystal display device will use what is termed an edge light type backlight device, in which the light source is deployed in a position close to an edge surface of the device, and use as its liquid crystal display panel what is termed a COG (chip on glass) type liquid crystal display panel, in which a driver IC for driving the liquid crystal is installed close to an edge surface of an array substrate. Such panel is placed over such backlight device. In such cases the light source and driver IC are often positioned one above the other and facing each other, in order to keep small the area of the frame portions, which are non-display areas.

However, a liquid crystal display device with such a structure has the problem that since the light source and driver IC are positioned close to each other, the heat generated by the light source passes to the driver IC, and the driver IC's drive performance declines as a result of such heat. This is particularly a problem where high-brightness LEDs (light-emitting diodes) are used for the light source, because they generate a large amount of heat.

As an example of a liquid crystal display device that resolves the above problem, the liquid crystal display device disclosed in Japanese Laid-Open Patent Publication No. 2003-330377 (FIG. 2, paragraphs [0006], [0007] and [0032]-[0034]) below will now be described with reference to FIG. 5, which is a transverse cross-sectional view of the electro-optic (liquid crystal display) device set forth in Japanese Laid-Open Patent Publication No. 2003-330377.

The electro-optic device 100 disclosed in Japanese Laid-Open Patent Publication No. 2003-330377 is equipped with a liquid crystal display panel 101, an illumination device 102 that illumines the liquid crystal display panel 101, and a frame 103 that houses the liquid crystal display panel 101 and the illumination device 102. The liquid crystal display panel 101 is of a structure such that liquid crystal is sealed between two glass transparent substrates 104, 105, and a driver IC 106 for driving the liquid crystal display part is mounted, COG, on the lower transparent substrate 105. The illumination device 102 is composed of a plurality of LEDs 107 and a light guide plate 108. The light guide plate 108 and the liquid crystal display panel 101 are fixed to the frame 103 by means of double-sided tape 110, which is frame-shaped and whose portion corresponding to the mounting area 105a for the driver IC 106 has a large width. Furthermore, one side of the double-sided tape 110, the driver IC 106 side, is a light-absorbing surface, while the other side, the LED 107 side, is a reflective surface of film.

With the above structure, although sunlight and other external light incidenting at the LEDs 107 propagates through the transparent substrates 104, 105, said incident light is attenuated due to the driver IC 106 sides of the transparent substrates 104, 105 being black-colored or otherwise light-absorbing surfaces. Thanks to this, the amount of external light that enters the driver IC 106 is extremely small and therefore will not cause malfunction of the driver IC 106. Also, light from the LEDs 107 is reflected by the reflecting side of the double-sided tape 110, with the result that such light does not directly strike the driver IC 106. Further, the heat generated by the LEDs 107 is prevented from heating the transparent substrates 104, 105 by the fact that the double-sided tape 110 reflects the light from the LEDs 107.

However, the electro-optic device disclosed in Japanese Laid-Open Patent Publication No. 2003-330377 still has the light source and driver IC deployed facing each other, and even though a thin double-sided tape is interposed between the light source and driver IC, the heat generated by the LEDs themselves will be transmitted to the driver IC.

Further, the LEDs which, as mentioned earlier, are used for the light source of the backlight device, have the characteristic that when their temperature rises, their relative light output drops, as is shown, for example, in the LED characteristic graph in FIG. 6. Additionally, as is plain from the LED characteristic graph in FIG. 7, the power loss that the LEDs are able to tolerate (their allowable power loss) is affected by their ambient temperature. Specifically, the allowable power loss decreases when the ambient temperature is high. Hence, it will not necessarily be possible to procure a high light output by increasing the power supplied, since supplying the LEDs with power exceeding the allowable level in this characteristic graph will break the LEDs. This means that in order to obtain a high light output it will be imperative to dissipate satisfactorily the heat that the LEDs generate.

However, when the LEDs and the driver IC are located close to each other as in the prior art described above, not only does the driver IC's temperature increase, but the heat that the driver IC generates during driving operation may be transmitted to the LEDs. In some cases this has resulted in a vicious circle of temperature increase, with each of the two promoting increase in the temperature of the other.

Liquid crystal display devices that are used for in-car applications are required to have particularly high brightness of, say, 500 candelas or over, far higher than the backlights used for mobile telephones. Thus, the brightness of the LEDs that are used in mobile telephones is inadequate for in-car applications. Accordingly, for in-car applications use is made of what are termed power LEDs, through which higher currents can be passed and which therefore have high brightness. But the use of power LEDs results in generation of greater heat compared to the LEDs used in mobile telephones, and this poses the risk of further speeding up the vicious circle of temperature increase that takes place between the driver IC and the LEDs.

### SUMMARY OF THE INVENTION

The present inventors arrived at the present invention by finding out, in examining the aforementioned problem, that if the driver IC and the LEDs are deployed so as to be distanced apart, there will be no danger of the heat that each generates being transmitted to the other, and hence it will be possible to curb decline in the driver IC's drive performance and in the LEDs' luminous efficiency.

More precisely, one purpose of the present invention is to provide a liquid crystal display device in which decline in the driver IC's drive performance due to transmission of heat from the light source can be prevented.

Another purpose of the present invention is to provide a liquid crystal display device having a light source with good luminous efficiency that can realize high brightness even when the LEDs are small-sized.

In order to achieve the aforementioned purposes, the liquid crystal display device of a first mode of the present invention is equipped with:

an edge light type backlight device having a light guide plate and a light source that is deployed close to an edge surface of said light guide plate; and

a liquid crystal display panel in which a pair of substrates is deployed facing each other, a liquid crystal layer is formed between the two substrates, and a driver IC for driving the liquid crystal is mounted on either one of said pair of substrates;

the liquid crystal display panel being placed over said backlight device;

and has the innovative feature that said driver IC is placed close to an edge other than the edge where the light source of said backlight device is located.

Moreover, said light source is preferably made up of one or more LEDs.

Furthermore, said driver IC is preferably placed at the opposite edge of said liquid crystal display panel to the edge where said light source of said backlight device is deployed.

Thanks to having the foregoing structure, the present invention exerts the excellent effects now described. Namely, in a liquid crystal display device of a first mode of the present invention, the liquid crystal display panel is placed over the backlight device in such a manner that the driver IC is deployed close to an edge of the liquid crystal display panel other than the edge where the backlight device's light source is located, and thereby the decline in the driver IC's drive performance that would result from transmission of the heat generated by the light source to the driver IC is prevented.

Further, when LEDs are used as said light source, a backlight device can be provided that, even though small-sized, will be bright, since the decline in the LEDs' luminous efficiency that would result from transmission of the heat generated by the driver IC to the LEDs will be prevented.

In addition, with the light source and driver IC deployed so as to be distanced apart from each other, there will be no transmission of the heat generated by the light source to the driver IC or vice-versa.

### BRIEF DESCRIPTION OF THE DRAWINGS

FIG. 1 is an exploded perspective view of a liquid crystal display device of an embodiment of the present invention.

FIG. 2 is a plan view of the liquid crystal display device in FIG. 1 when assembled.

FIG. 3 is a cross-sectional view on III-III in FIG. 2.

FIG. 4 is a cross-sectional view on IV-IV in FIG. 2.

FIG. 5 is a transverse cross-sectional view of a prior art electro-optic device.

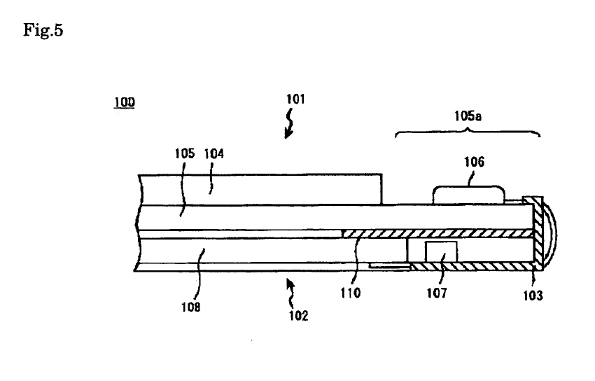

FIG. 6 is a graph of the temperature versus light output characteristic of a LED.

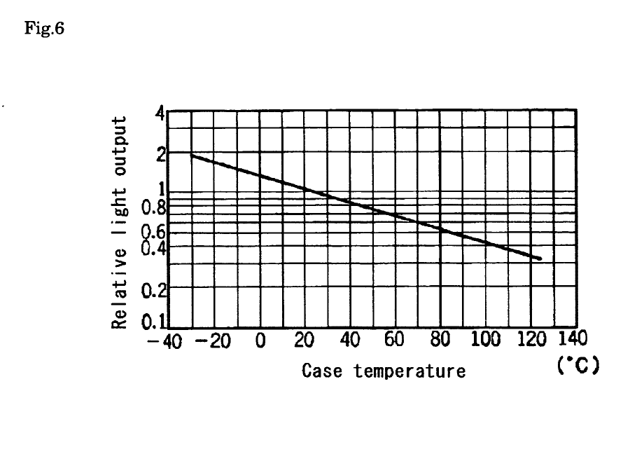

FIG. 7 is a graph of the allowable power loss versus temperature characteristic of a LED.

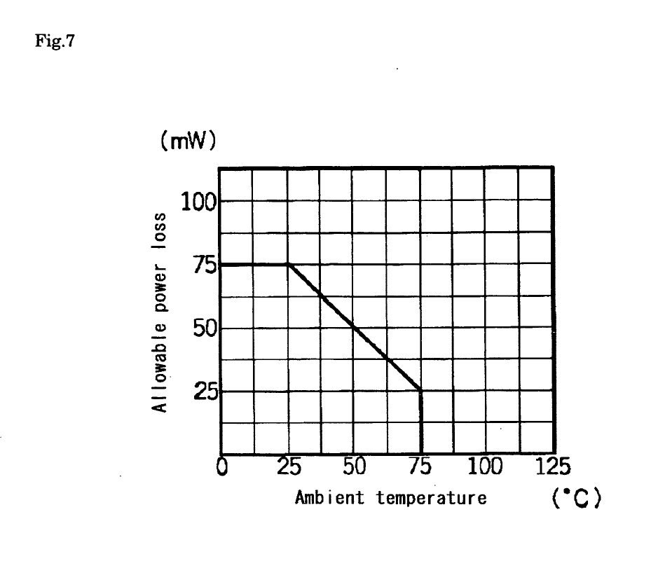

### DESCRIPTION OF THE PREFERRED EMBODIMENT

A preferred embodiment of the present invention will now be described with reference to the drawings. However, the embodiment below represents merely an illustrative instance of a liquid crystal display device for realizing the technical thought of the present invention; this embodiment is not intended to limit the present invention to this particular liquid crystal display device. The invention can equally well be adapted to other modes contained in the scope of the claims.

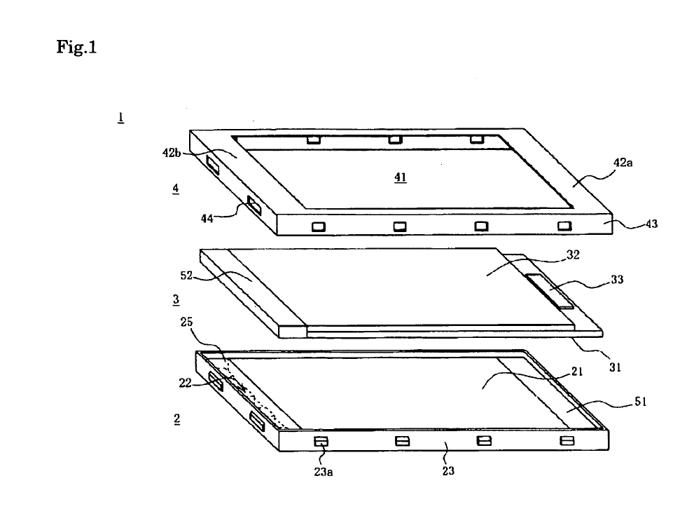

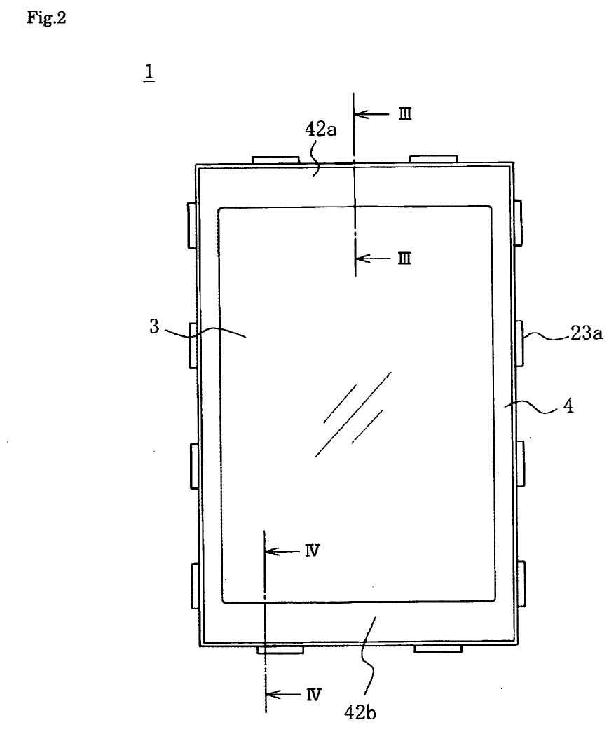

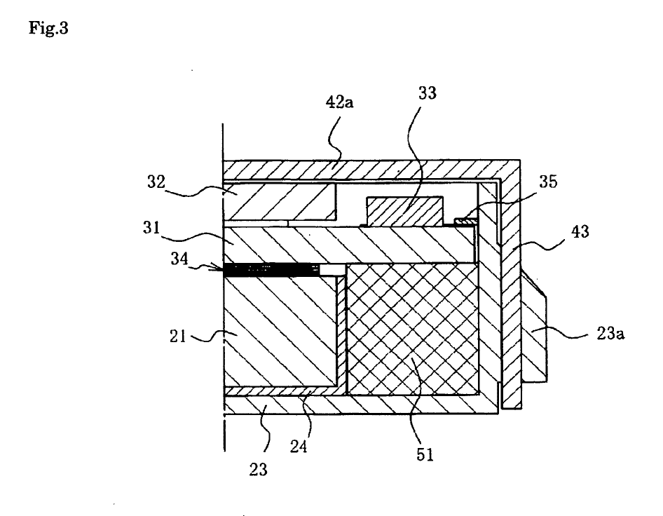

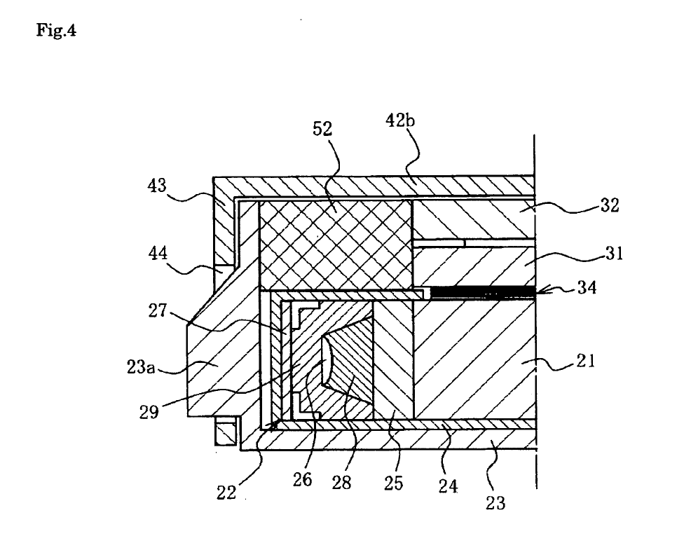

FIG. 1 is an exploded perspective view of a liquid crystal display device of an embodiment of the present invention, FIG. 2 is a plan view of the liquid crystal display device in FIG. 1 when assembled, FIG. 3 is a cross-sectional view on III-III in FIG. 2, and FIG. 4 is a cross-sectional view on IV-IV in FIG. 2. Such liquid crystal display device 1 of the present invention is composed of a backlight device 2, a liquid crystal display panel 3, and a front case 4, as shown in FIGS. 1 and 2.

The backlight device 2 is an edge light type backlight device, and includes:

a box-shaped rear case 23 whose upper portion is open;

a light guide plate 21 that is made of plate-form polymethyl methacrylate (PMMA) and is housed inside the rear case 23;

a light source 22, made up of LEDs, that shines light toward one edge of the light guide plate 21;

a reflective sheet 24 (see FIG. 4) that is provided so as to cover the light guide plate 21 and light source 22; and

resin material 25 that is interposed in the gap between the light guide plate 21 and light source 22 and is formed so as to cover the light source. Part of the reflective sheet 24 is omitted in FIG. 1 to render the light source 22 more clearly visible. Additionally, a first cushioning 51 is provided in contact with that edge among the light guide plate 21's edges that is opposite to the edge where the light source 22 is provided.

The liquid crystal display panel 3 is a COG type liquid crystal display panel, and includes:

an array substrate (below, “AR substrate”) 31, on the inner face of which is formed a particular wiring pattern, such as multiple gate wires and multiple source wires in a lattice arrangement;

a color filter substrate (below, “CF substrate”) 32 that is deployed facing the AR substrate 31, has a color filter layer formed on the inner face, and is somewhat smaller-sized than the AR substrate 31;

a driver IC 33 that is provided on the surface of the AR substrate 31 close to one edge, and is for applying control voltage to the wirings of the two substrates; and

a flexible wiring board 35 (see FIG. 3) that is connected to the driver IC and is for implementing supply of voltage, etc., from the exterior. A liquid crystal layer is formed in the interior space that results when the two substrates 31, 32 are bonded together facing each other by means of sealing material. On the outer face of this liquid crystal display panel there is provided a polarizing plate that is not shown in the drawings. Additionally, a second cushioning 52 is provided in contact with that edge, among the edges of the liquid crystal display panel 3 thus formed, that is opposite to the edge where the driver IC 33 is mounted. Further, the driver IC 33, though shown in the drawings at a shorter edge of the liquid crystal display panel 3, could equally well be formed at a longer edge.

The front case 4 is a frame-shaped rim structure with a window 41 in the central portion, is somewhat larger than the rear case 23, and has sidewalls 43 that project downward a certain distance from each edge and are provided with latching holes 44 into which the latching bars 23a provided on the sidewalls of the rear case 23 latch. Of the four rim pieces that make up the front case 4, the opposed pair of rim pieces 42a, 42b are formed with a large breadth compared to the other pair.

The assembled state of the liquid crystal display device of the present embodiment is now described in detail with reference to FIGS. 2 to 4.

FIG. 2 is a plan view showing the liquid crystal display device 1 in the assembled state. To assemble the liquid crystal display device 1, multiple optic sheets 34 including an optic sheet and prism sheet, etc., are placed over the backlight device 2, after which the liquid crystal display panel 3 is placed over the backlight device 2 in such a manner that the display area of the liquid crystal display panel 3 and the light-radiating area of the light guide plate 21 are superposed. Over such assembly is then mounted the frame-shaped front case 4 so that the display area of the liquid crystal display panel 3 is exposed through the window 41, and the resulting whole is held together by making the latching bars 23a of the rear case 23 latch into the latching holes 44 provided in the sidewalls 43 of the front case 4. In this way, the liquid crystal display panel 3's driver IC 33 is covered by one broad rim piece 42a of the front case 4, while the backlight device 2's light source 22 is covered by the other broad rim piece 42b of the front case 4.

In the portion that is covered by the broad rim piece 42a, the area of the AR substrate 31 where the driver IC 33 is mounted extends a certain distance beyond the end portion of the light guide plate 21, as shown in FIG. 3. In the space below such extended portion there is provided a first cushioning 51 for alleviating impacts, etc., from the exterior. This cushioning will preferably be of silicon rubber, for example. Using silicon rubber for this first cushioning 51 can be expected to enhance the insulation properties, and, since this cushioning is in contact with the AR substrate 31, on which the driver IC 33 is mounted, will enable heat generated by the driver IC 33 to be dissipated to the exterior via conduction through the rear case 23, for example, thereby preventing decline in the drive performance of the driver IC 33. Although in the present embodiment it is cushioning that is provided in the space below such extended portion, alternatively a material containing carbon or the like could be provided in cases where a light blocking effect is required, or a material with good heat conductance could be provided in cases where heat dissipation performance is required.

In the portion that is covered by the other broad rim piece 42b, is deployed the backlight device 2's light source 22, above which there is provided a second cushioning 52 of silicon rubber or similar, which contacts against an edge surface of the liquid crystal display panel 3. In the present embodiment the light source 22 is composed of a plurality (four in FIG. 1) of LEDs that are mounted on a film wiring board 27. These LEDs are formed from a light-emitting element 26 and a light-emitting element mounting board 29, made up of a ceramic plate, etc., that is rectangular and has a particular hollow 28 formed in the central portion of one side. The hollow 28 in the light-emitting element mounting board 29 has a flat bottom and a peripheral wall that slopes at a certain angle to form an abbreviated cone shape. It is on the flat surface of the hollow 28 that the light-emitting element 26 is mounted. The light-emitting element 26 is electrically connected to the film wiring board 27 and is lighted by being supplied with power from the film wiring board 27. The hollow 28's wall is processed into a mirror surface and its interior is filled with epoxy or silicon transparent resin, which is commonly used as the molding resin for. LEDs. The top surface of this epoxy or silicon transparent resin is made to be uniformly flush with the surface of the light-emitting element mounting board 29.

Moreover, resin material 25 of silicon rubber or similar is fitted between the light-radiating surface of the LED and the edge surface of the light guide plate 21, and between the film wiring board 27 and the edge surface of the light guide plate 21. Through deployment of this resin material 25, total reflection of the light can be satisfactorily curbed, and in addition the heat generated by the LED is satisfactorily dissipated by being conducted to the exterior. If the second cushioning 52 is made of silicon rubber, as is the case with resin material 25, the heat dissipation efficiency will be further enhanced. The material of the second cushioning 52 can be varied to suit the application just as can that of the first cushioning 51.

According to the foregoing, the driver IC 33 and the light source 22 are each covered by one of a pair of opposed rim pieces, namely by the rim pieces 42a and 42b respectively, thereby enabling the driver IC 33 and the light source 22 to be provided in positions that are distanced apart. As a result, there is no danger that the heat generated by either one will lower the performance of the other, and in addition, cushioning or similar can be provided in the spaces that are created by such arrangement. Because of such features, it will be possible to achieve a dramatic improvement in impact resistance or heat dissipation performance.

Thus, according to the liquid crystal display device of the present invention, the driver IC and the light source are not, as has been conventional in the prior art, deployed facing each other, one above and the other below. Consequently, the adverse effects that the heat generated by each has heretofore exerted upon the other are eliminated, and in addition, where LEDs are used as the light source, high brightness can be obtained even if the LEDs are small-sized. What is more, a liquid crystal display device can be provided whose driver IC will rarely suffer failures even if LEDs with high heat discharge such as power LEDs are used.

What is claimed is:

1. A liquid crystal display device comprising:
an edge light type backlight device having a light guide plate and a light source that is deployed close to an edge surface of said light guide plate; and
a liquid crystal display panel wherein a pair of substrates are deployed facing each other, a liquid crystal layer is formed between the pair of substrates, and a driver IC for driving the liquid crystal is mounted on either one of said pair of substrates;
the liquid crystal display panel being placed over said backlight device;
said driver IC being placed close to an edge other than the edge where the light source of said backlight device is located.

2. The liquid crystal display device according to claim 1, wherein said light source comprises at least one light-emitting diode.

3. The liquid crystal display device according to claim 1, wherein said driver IC is placed at the opposite edge of said liquid crystal display panel to the edge where said light source of said backlight device is deployed.
